(19) United States
(12) Patent Application Publication
(10) Pub. No.: US 2025/0335918 A1
(43) Pub. Date: Oct. 30, 2025

(54) SYSTEMS AND METHODS FOR USE IN IDENTIFYING INTELLIGENT RECOMMENDATIONS BASED ON NETWORK BENCHMARKS

(71) Applicant: MASTERCARD ASIA/PACIFIC PTE. LTD., SINGAPORE (SG)

(72) Inventors: Antonino Cartia, Roma (IT); Daria Gustova, Lisbon (PT); Fabio Malgieri, Milano (IT); Marco Cortellari, Milano (IT); Nikhil Anand Malgatti, Pune (IN); Piyush Choudhary, Bangalore (IN); Pratham Shukla, Meerut (IN); Sarang Bajrang Pujari, Pune (IN); Xiao Hui Heng, Singapore (SG); Rahul Ajmani, Mumbai (IN)

(21) Appl. No.: 19/188,880

(22) Filed: Apr. 24, 2025

(30) Foreign Application Priority Data
Apr. 26, 2024 (IN) 202441033523

(51) Int. Cl. G06Q 20/40

(52) U.S. Cl. CPC G06Q 20/4016

(57) ABSTRACT

Systems and methods are provided for identifying recommendations, based on network benchmarks. One example method includes accessing, by a service platform computing device, data specific to a participant, the data representative of multiple transactions; calculating a first metric based on the accessed data, the first metric indicative of a rate of the transaction represented by the accessed data; identifying a recommendation based on a trigger rule, which defines a relationship between at least one benchmark and the first metric; and displaying the recommendation to a user associated with the participant.

### CROSS-REFERENCE TO RELATED APPLICATION

This application claims the benefit of, and priority to, Indian Application No. 202441033523 filed on Apr. 26, 2024. The entire disclosure of the above application is incorporated herein by reference.

### FIELD

The present disclosure generally relates to systems and methods for use in identifying intelligent recommendations based on network benchmarks, and in particular, for use in identifying intelligent recommendations for enhanced operation of participants, based on network benchmarks for certain rates and subject matter expertise.

### BACKGROUND

This section provides background information related to the present disclosure which is not necessarily prior art.

Network traffic is representative of network interactions between two or more parties. In many processing networks, the number of interactions is substantial (e.g., millions, tens of millions, or more per day, etc.). Assessment of operation of the processing networks, in general or specific to one or more participants, requires assessment of a substantial volume of data, whereby issues may be identified where proper interactions are not permitted and improper interactions (e.g., fraudulent transactions, etc.) are permitted. Investigation may then be required to determine the extent of the issue for the interactions, and remedial action to be imposed.

### DRAWINGS

The drawings described herein are for illustrative purposes only of selected embodiments and not all possible implementations and are not intended to limit the scope of the present disclosure.

FIG. 1 illustrates an example system of the present disclosure suitable for use in identifying intelligent recommendations, based on network benchmarks, for network transactions;

FIG. 2 is a block diagram of an example computing device that may be used in the system of FIG. 1;

FIG. 3 is an example method that may be implemented in connection with the system of FIG. 1 for use in identifying recommendations, based on network benchmarks, for network transactions; and

FIG. 4A-4C illustrate example interfaces that may be used in connection with the method of FIG. 3.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

In connection with issues within a processing network related to proper interactions not being permitted and improper interactions (e.g., fraudulent transactions, etc.) being permitted, investigation of the specific participants may be time consuming and cumbersome, especially for ever evolving and increasingly sophisticated forms of fraud being attempted in connection with interactions. Subject to this condition, participants in the processing network are required to consistently improve authorization rates and manage fraud to avoid substantial losses. Often, the substantial volume of interactions or transactions impedes comprehensive assessment of the participants, and processes imposed thereby, especially in the absence of industry-based benchmarks and disparate data indicative of the transactions to the participants.

Uniquely, the systems and methods herein enable the identification of timely and actionable recommendations to enhance performance, by participants, in permitting proper transactions, while inhibiting improper transactions.

In particular, the subject matter expertise (SME) associated with permitting transactions, and addressing issues related to missed transactions (e.g., improper declines, improper approvals, etc.), is compiled into recommendations, and trigger rules are associated with the recommendations based on objective metrics of participants. In this way, by measuring the metrics of the participants and utilizing the trigger rules, a service platform is permitted to identify recommendations for the participants, which are timely and suited to address issues related to improper transactions of the participants. In this manner, comprehensive assessment of the specific participants is avoided, in favor of leveraging the subject matter expertise associated with the service platform to rapidly identify actionable recommendations suited to the particular metrics of the participants. The recommendations may be identified in seconds, as compared to the days, weeks, etc., of comprehensive assessments of the specific participants' policies, rules, etc. and voluminous data representative of transactions, leading to the specific missed transactions.

As such, the systems and methods herein provide technical solution which reduces assessment of substantial volumes of network data, i.e., a technical problem, while providing targeted recommendations to address network issues specific to individual participants.

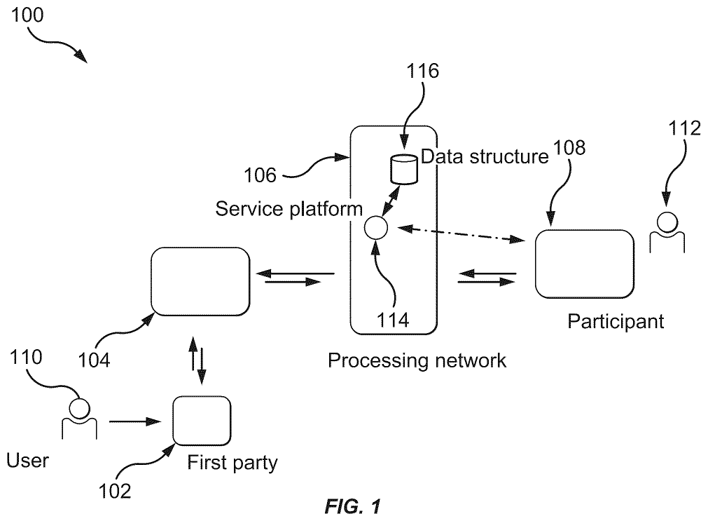

FIG. 1 illustrates an example system 100 in which one or more aspects of the present disclosure may be implemented. Although the system 100 is presented in one arrangement, other embodiments may include systems arranged otherwise depending, for example, on processing of transactions, participants involved in the transactions, manners in which transactions are initiated, privacy concerns, rules, and regulations, etc.

In the illustrated embodiment, the system 100 generally includes a first party 102, an acquirer 104, a processing network 106, and an issuer (or participant) 108, each coupled to (and in communication with) one or more networks (as generally indicated by arrowed lines in FIG. 1). The network(s) may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, the network may include multiple different networks, such as a private payment transaction network made accessible by the processing network 106 to the acquirer 104 and the issuer 108 and, separately, the public Internet, which is accessible as desired to the first party 102, the processing network 106, the issuer 108, and one or more various users in the system 100 (e.g., user 110, user 112, etc.), etc.

The first party 102 is generally a merchant associated with offering products for purchase to one or more users, including, for example, the user 110, etc. The first party 102 may include a physical location (e.g., brick-and-mortar location, etc.), or virtual locations (e.g., accessible via a web application, etc.).

In the example embodiment illustrated in FIG. 1, the acquirer 104 is a financial institution, such as, for example, a bank. The acquirer 104 is configured to issue an account to the first party 102. The account may be a payment account, or checking account, or other type of bank account, which is designated as the account into which the first party 102 is to receive funds from purchase transactions. Similarly, in this example embodiment, the issuer 108 is a financial institution, such as, for example, a bank. The issuer 108 is configured to issue accounts to users, including, for example, the user 110. The account(s) may be a payment account or other type of bank account, from which the user 110 is permitted to pay funds to another party. In the description herein, the issuer 108 is also referred to as a participant, in connection with a service platform 114, in that the issuer 108 participates in the service(s) offered by the service platform 114.

Each of the acquirer 104 and the issuer 108 are associated with the processing network 106. The processing network 106 may include, for example, the MASTERCARD, VISA, or DISCOVER processing network, etc. The processing network 106 is configured to facilitate messaging between the acquirer 104 and the issuer 108, generally, in connection with transactions between users and the first party 102 (and other first parties). The messaging may include, for example, authorization messages, clearing messages, etc., which may be consistent with the international standard for financial transaction card originated interchange messaging, ISO 8583, or ISO 20022, each of which is published by the International Organization for Standards, or other suitable standards, etc.

The user 110 may also be associated with a communication device. The communication device may include a smartphone, a tablet, a personal computer, a laptop, a desktop, a workstation, a PDA, etc., which is coupled to and/or is in communication with the issuer 108 (e.g., via an application associated with the issuer 108, via a web browser, or otherwise, etc.), for example, via the network.

In connection with a transaction, the user 110 indicates an interest to purchase one or more products from the first party 102, and decides to purchase the one or more products, whereupon the user 110 presents a credential specific to the account issued by the issuer 108 to the first party 102.

Based thereon, the first party 102 is configured to generate an authorization request for the transaction to be funded by the user's payment account and to communicate the authorization request to the acquirer 104. The authorization request includes various data representative of the transaction, such as, for example, amount, name and/or identifier of the first party 102, location data of the first party 102, merchant category code (MCC) for the first party 102, currency, transaction ID, timestamp (e.g., date/time, etc.), acquirer data, the credential (e.g., account data (e.g., token, primary account number (PAN), expiration date, CVC, etc.), etc.), etc. It should be appreciated that in one or more embodiment, the acquirer 104 is configured to generate the authorization request, based on data received from the first party 102.

In turn, the acquirer 104 is configured to communicate the authorization request to the processing network 106.

Upon receipt, the processing network 106 is configured to communicate the authorization request to the issuer 108. In response, the issuer 108 is configured to assess the authorization request and to determine whether, or not, to authorize the transaction. The issuer 108 is configured to compile an authorization response (or reply), which indicates whether, or not, the transaction is authorized. The authorization response, when the transaction is declined, includes a decline code, which is indicative of the reason for the decline. Decline codes may include, for example, insufficient funds, expired card, transaction not permitted, invalid PIN, etc. It should be appreciated that other decline codes may be relevant based on a type of account (e.g., credit, debit, etc.) and terms associated therewith. For example, for a debit card, an ATM withdrawal transaction (as compared to a purchase transaction) may result in decline code for exceed withdrawal limit amount, etc. Conversely, when the transaction is approved, other suitable data indicative of the approval may be included in the authorization request.

The issuer 108 is further configured to communicate the authorization response to the processing network 106. The processing network 106, in turn, is configured to communicate the authorization response to the first party 102, via the acquirer 104. In should be understood that additional messaging associated with clearing and settlement may be exchanged between the acquirer 104, the processing network 106, and the issuer 108, as applicable.

In this exemplary embodiment, the processing network 106 is configured to collect, compile and store certain transaction data in a data structure 116.

The transaction data may include, without limitation, primary account numbers (PANs), tokens, expiration dates, CV Cs, an identifier of the issuer 108, an identifier of the acquirer 104, transaction IDs, terminal IDs, address data, merchant category codes (MCCs), times, dates, first party data, decline codes, transaction amounts, card present (or card not present) data, product types (e.g., credit, debit, etc.), cross-border data, product groups, or other suitable data representative of the transaction, the parties involved, results of the transaction, etc.

With reference to FIG. 1, it should be appreciated that the first party 102, the acquirer 104, and the issuer 108 are representative of many different first parties, acquirers, and issuers. In connection therewith, the processing network 106 is configured to collect, compile, and store the transaction data for transactions processed therethrough, for many users, acquirers, issuers etc. In this way, the data structure 116 of the processing network 106 includes data representative of, for example, millions, tens of millions, hundreds of millions, or more or less transactions, in a day or week, for example, as records indicative of transactions processed by the processing network 106. What's more, while the description above is generally directed to a four-party transaction, the transaction data may be representative of other types of transactions, including, for example, real-time transactions, three-party transactions, person-to-person (P2P) transactions, business-to-business (B2B) transactions, or combinations thereof, etc., where the transaction processing or other facilitation includes the processing network 106, or where the processing network 106 is informed of the transactions, etc.

It should be appreciated that the transaction data is stored by the processing network 106 in the transaction data structure 116 pursuant to permissions as defined by relevant agreements with applicable parties, rules, and regulations.

That said, from time to time, approved transactions are reported by users, including the user 110, as being fraudulent. In connection therewith, the issuer 108 is configured to perform some form of investigation, generally, and, when the fraud report is confirmed, to refund the account of the user 110, for example, for the amount of the fraudulent transaction. As part thereof, the issuer 108 is configured to report the fraud to the processing network 106. In turn, then, the processing network 106 is notified of the fraud status of the transaction, for example, through direct messaging, or potentially, chargeback messaging or other messaging associated therewith, etc., whereby the processing network 106 is further configured to augment the transaction data collected, compiled, and stored in the data structure 116 with one or more fraud designations for the particular transaction identified by the issuer 108.

Based on the above, transaction data in the data structure 116 is sufficient to determined approval rates (or decline rates) for the issuer 108, and also fraud rates for the issuer 108, as explained below. That said, it should be appreciated that other rates associated with the issuer 108 may be determined in other embodiments, for use, as explained below. What's more, the transaction data may include still further data upon which other suitable rates may be determined in other system embodiments.

In this exemplary embodiment, the system 100 includes the service platform 114, which is included in the processing network 106 as shown in FIG. 1. It should be appreciated that while the service platform 114 is included in the processing network 106 in this embodiment, it may be a standalone computing device, in whole or in part, along with the data structure 116, in other embodiments. Regardless, the service platform 114 is configured to access the transaction data in the data structure 116.

In this exemplary embodiment, the service platform 114 is configured to determine rates associated with the issuer 108, to identify recommendations specific to the rates (and the issuer 108), and to offer the recommendations to the issuer 108.

In connection with the above, the issuer 108 is configured to enroll, as a participant, with the service platform 114. In particular, a user 112 is associated with the issuer 108 (e.g., as an employee, contractor, manager, executive, etc.), whereby the user 112 seeks to improve the performance of the issuer 108, in terms of approval rate and/or fraud rate, in this example embodiment. As such, the user 112 enrolls the issuer 108 to receive recommendations related, in this embodiment, to authorization, authentication, and fraud. In turn, in response to enrollment or further interaction of with the user 112 of the issuer 108, the service platform 114 is configured to access the transaction data included in the data structure 116, in general and specific to the issuer 108. Based on the accessed transaction data, the service platform 114 is configured to calculate one or more metrics of the issuer 108. In particular, in this exemplary embodiment, the service platform 114 is configured to calculate an approval rate (or decline share) and a fraud rate. The approval rate is the number (or dollars) of transactions that are approved divided by the total number (or dollars) of transactions, thereby indicating a percentage, etc., and the fraud rate is the number (or dollars) of transactions designated as fraud divided by the total number (or dollars) of transactions, thereby indicating a percentage, etc.

The accessed transaction data may be limited to a prior interval, such as for example, the last 30 days, the last 60 days, the last 90 days, 120 days, six months, etc.

It should be appreciated that the transaction data compiled into the metrics for the issuer 108 may be limited to different categories of the transactions involving the issuer 108. The categories may include, without limitation, segments (e.g., consumer, business, etc.), product (e.g., credit, prepaid, debit, etc.), channel/type (e.g., card not present (CNP), card present (CP), etc.), sub-channel (e.g., recurring, e-commerce, etc.), geography, etc. In addition, categories for the approval rate may include different decline codes (e.g., insufficient funds, do not honor, invalid PIN, etc.). In connection with seeking recommendation(s), or enrolling with the service platform 114, the user 112 may indicate one or more categories of interest, or not (whereby all categories, or a portion thereof are considered).

In this exemplary embodiment, the data structure 116 further includes recommendations for authentication, authorization, and fraud. The recommendations are compiled based on subject matter expertise included in the processing network 106 and users thereof, whereby each recommendation, in general, is based on logic drawn from prior investigations related to decline rates (or alternatively, approval rates) and/or instances of fraud, and the resolutions associated with the investigations or tools implemented therefore. Example recommendations related to declined transactions are included in Table 1, and example recommendations related to fraud are included in Table 2.

As shown in Table 1, each example recommendation includes a recommendation name, description of the recommendation, and a relevance to a product. The example recommendations in Table 1 are specific to a decline code for insufficient funds. It should be appreciated that various other recommendations, related to the specific decline code(s), or other decline codes may be included in the data structure 116. For example, recommendations may be specific to decline codes for do not honor, expired card, exceeds the limit, invalid PIN, transaction not permitted by issuer/cardholder, and other decline bases, etc.

TABLE 1

| | | | |
|---|---|---|---|
| | Recommendation | | |
| # | Name | Recommendation | Relevance |

Decline Code: Insufficient Funds

| | | | |
|---|---|---|---|
| 1 | Introduce | Consider implementing shadow limits to allow | CREDIT |
| | shadow limits | cardholders to temporarily exceed their agreed | |
| | | credit limit. | |
| 2 | Review | Review credit limits periodically and increase | CREDIT |
| | maximum credit | limits for targeted cardholders in accordance | |
| | limit amount | with credit risk assessment. | |
| | periodically | | |
| 3 | Communicate | Generate instant notifications for declined | CREDIT, |
| | decline reason | transactions specifying the decline reason | DEBIT, |
| | | clearly & the required steps to resolve issue (if | PREPAID |
| | | applicable). | |
| 4 | Implement | Implement an automated funds transfer feature | CREDIT |
| | automated funds | (i.e., sweep-in funds), whereby funds are | |
| | transfer | automatically transferred into the card account | |
| | | from alternate funding source when the | |
| | | available balance or open-to-buy falls below a | |
| | | set threshold. | |

Decline Code: Do Not Honor

| | | | |
|---|---|---|---|
| 5 | Optimize retries | Utilize Merchant Advice Codes (MAC) to | CNP |
| | using Merchant | communicate the necessary action to be taken | |
| | Advice Codes | by the merchants. I | |
| | (MAC) | | |
| 6 | Review and clear | Establish a monitoring process to review | All |
| | temporary blocks | temporary blocks and implement an end-of-day | |
| | | clearance procedure for the automatic removal | |
| | | of temporary block codes if they are no longer | |
| | | applicable. | |

Decline Code: Expired Card

| | | | |
|---|---|---|---|
| 7 | Leverage | Ensure compliance with Mastercard Automatic | CNP, |
| | Mastercard | Billing Updater (ABU) mandates and fully | Consumer |
| | Automatic | utilize ABU to securely communicate account | |
| | Billing Updater | updates to credential-on-file and recurring | |
| | (ABU) | payments merchants. | |

Decline Code: Exceeds Withdrawal Amount Limit

| | | | |
|---|---|---|---|
| 8 | Create proactive | Generate proactive early warning alerts when | CP, ATM |
| | alerts for | cardholders reach 80% of the | |
| | withdrawal | daily/weekly/monthly withdrawal limit. | |
| | thresholds | | |

Decline Code: Invalid PIN

| | | | |
|---|---|---|---|
| 9 | Send notification | Immediately send a real-time notification to the | CP |
| | for incorrect PIN | cardholder after an incorrect PIN decline, | |
| | declines | providing instructions to reset or request a new | |
| | | PIN. | |

As shown in Table 2, like above, each example recommendation includes a recommendation name and description of the recommendation. The example recommendations in Table 2 are specific to fraud (whereby no decline code is available). It should be appreciated that various other fraud type recommendations may be included in the data structure 116. Other recommendations, for example, may relate to defining a fraud detection strategy, optimizing fraud false positive rates, designing decision trees for fraud detection, leveraging decision intelligence scores, creating multi channel alerts, etc.

TABLE 2

| | Recommendation | | |
|---|---|---|---|
| # | Name | Recommendation | Relevance |
| 10 | Leverage all data | Leverage all available data elements | Credit, Debit, |
| | points of the | present within Auth message to optimize | Pre-Paid |
| | Authorization | fraud rule sets. | |
| | message | | |
| 11 | Implement Early | Develop Early Month on Book (EMOB) | Credit, Debit, |
| | Month On Book | Fraud strategies for all new cardholders | Pre-Paid |
| | (EMOB) | starting from card delivery phase. | |
| | strategies | | |
| 12 | Review and | Deploy targeted, tiered blocking | Credit, Debit, |
| | optimize card | functionality by card presence, POS | Pre-Paid |
| | blocking features | entry mode and other strategic | |
| | | spending/transaction drivers to more | |
| | | effectively strike the balance between | |
| | | customer experience and fraud risk. | |
| 13 | Set and optimize | Define a risk appetite to allow the | Credit, Debit, |
| | fraud risk | alignment between business needs and | Pre-Paid |
| | appetite | fraud strategy indicators and parameters. | |

It should be appreciated, again, that any different type of recommendation may be compiled from the subject matter expertise of the processing network 106, or otherwise, whereby the present disclosure is not limited to the example recommendations above.

In addition to the specific recommendations above, each of the recommendations is associated with trigger rules based on benchmarks associated with the processing network 106 relative to the calculated shares/rates of the issuer 108 (e.g., decline share, approval rate, fraud rate, etc.) (broadly, metrics, etc.). The specific recommendations may be further limited by the categories of transactions explained above, whereby a recommendation may be specific to a product, channel, sub-channel, and/or geography, etc. With regard to the trigger rules, the service platform 114 is configured to calculate the approval rate, as benchmarks in counts or in dollars, for various issuers included in the transaction data of the data structure 116.

It should be appreciated that the benchmarks may be optionally limited to a minimum number of issuers to ensure privacy considerations (e.g., more than 15, 20, 35, or 50 issuers, etc.), which may be different for different benchmarks. It should also be appreciated that the benchmarks may further, or alternatively, be specific to one or more percentiles of the issuers included in the transaction data (e.g., 50 percentile, 15 percentile, 85 percentile, etc.).

As an example calculation, in calculating a 50th percentile benchmark approval rate, the service platform 114 is configured to, for each issuer, rank the values in the data set from smallest to largest and multiply 0.5 (i.e., 50 percent) by the number of values in the data set to define the index, k. If the index is not a round number, the service platform 114 is configured to round the index to the nearest whole number. Next, the service platform 114 is configured to count the rates, from smallest to largest to the index, or k-th rate, and to identify a number of rates above and below the k-th rate, i.e., k-2th rate, k-1th rate, k+1th rate, k+2th rate, etc. The service platform 114 is configured to average the identified rates for the issuers (as identified when the index is a whole number, and with an additional k+3rd, if not), which defines the 50th percentile benchmark approval rate. In a numeric example, where there are 50 issuers, the service platform 114 is configured to count up to the 25th rate, and identify the 23rd, 24th, 25th, 26th, 27th rates and to average the corresponding rates to get the 50th percentile approval rate. Alternatively, in another numeric example, for a 15th percentile, the index would be 0.15 multiplied by the number of values, or 7.5, which is rounded to 8, where the service platform 114 is configured to count up 8 values from the smallest to get the 8^{th} rate, and also consider the 6th, 7th, 9th, 10th and 11th rates as an average to get the 15th percentile approval rate.

It should be appreciated that other rate or share benchmarks, for either the approval rate or the fraud rate, may be determined in a similar manner, to assess the industry or categories thereof.

What's more, as it relates to the trigger rules for recommendations, one example related to approval rate includes benchmarks such as, without limitation, 50th percentile benchmark approval rate, best in class benchmark approval rate, participant previous quarter approval rate, defined threshold (e.g., 95%, 98%, etc.). In connection therewith, the service platform 114 is configured to evaluate, for example, as it relates to approval rate, 1) whether the 50th percentile benchmark approval rate minus the participant approval rate is greater than 2percentage points, 2) whether the best in class benchmark approval rate (for a class including the participant) minus the participant approval rate is greater than 2 percentage points, and if neither 1) or 2), then, 3) whether the participant's previous quarter approval rate minus the participant approval rate is greater than 1.5 percentage points, and if not 3), then whether the participant approval rating is less than a defined threshold.

In another example related to fraud rate, as it relates to the trigger rules for recommendations, the benchmarks may include for example, without limitation, a 50th percentile benchmark fraud rate, best in class benchmark fraud rate, participant previous quarter fraud rate, defined threshold, etc. In connection therewith, the service platform 114 is configured to evaluate, for example, as it relates to broad rate, 1) whether the participant fraud rate minus the 50th percentile benchmark fraud rate is greater than 2 percentage points, 2) whether the participant fraud rate minus the best in class benchmark fraud rate (for a class including the participant) is greater than 2 percentage points, and if neither 1) or 2), then, 3) whether the participant fraud rate minus the participant's previous quarter approval rate is greater than 1.5 percentage points, and if not 3), then whether the participant approval rating is less than a defined threshold.

It should be appreciated that the specific trigger rules, ordering and thresholds for either approval rates or fraud rates, or both, may be specific to the particular recommendations in various embodiments, and thus different than the examples above.

With reference to the above, the service platform 114 is configured to identify ones of the specific recommendations for the issuer 108 based on the trigger rules for the particular recommendations.

Further, in this exemplary embodiment, the service platform 114 is configured, as part of enrollment of the issuer 108 or in connection with the user 112 later seeking recommendations, to solicit readiness information from the issuer 108. The readiness information may be related to technology readiness, risk and fraud readiness, and marketing readiness. The readiness information, more generally, is related to the issuer's readiness to implement one or more of the recommendations, for example, where the recommendations relate to improving an approval rating, a technical readiness question may solicit a degree of flexibility in implementing and adapting authentication systems, authorization systems, and also a time to implementation for an authorization rule change, etc.

In particular, the service platform 114 is configured to display one or more interfaces to the user 112 of the issuer 108, which include queries related to readiness. In response to inputs from the user 112 of the issuer 108, the service platform 114 is configured to compile the response into readiness information for the issuer 108 and to assign a score to each recommendation based on the input from the user 112 (of the issuer 108) to indicate whether the issuer 108 is able to match the SM E prescribed ease of implementation in the recommendation. If not, the service platform 114 is configured to not include the recommendation, in this example, as part of the recommendation interface, after readiness assessment. It should be appreciated that additional queries related to feedback, existing products, etc., also may be directed the user 112 at the issuer 108 with input from the user 112 compiled with the readiness information for the issuer 108.

In this exemplary embodiment, the service platform 114 is configured to filter the recommendations for the issuer 108 based on the readiness information received from the issuer 108. In this way, one or more recommendation, which are not suited to the readiness of the issuer 108 may be eliminated or omitted.

Next, the service platform 114 is configured to display the recommendations to the user 112, whereby the recommendations may be accompanied by suitable information related to the performance of the issuer 108 (e.g., approval rate, fraud rates, etc.), by categories, etc., and association of the specific recommendations for the respective rate (e.g., “What to do,” etc.). The recommendation interface may also include information related to implementation difficulty (e.g., easy, medium, difficult, etc.) (e.g., as designated by subject matter experts, etc.) and business potential as an indicator of the potential impact of the recommendation on the performance of the issuer 108 (e.g., as indicated by the approval rates, fraud rates, etc.). This may be indicated in narrative or numeric form.

In particular, as it relates to business potential, the service platform 114 is configured to identify the highest, or top, decline reason codes for the issuer 108. The decline volumes (e.g., in dollars) are divided by four for insufficient funds, and two for other reasons, to normalize the volumes. This is illustrated, for example, in Table 3 below.

TABLE 3

| | | Volume Decline by | | |
|---|---|---|---|---|
| | | Top Decline Reason | Normalized | |
| | Target Decline | (Top Decline Reason | business potential | |
| Recommendation | Reason | #1 in KPI sheet) | Formula and value | GRP |
| R1 | Insufficient | 1,00,000 | 1,00,000/4 = 25,000 | 4 |
| | Funds | | | |
| R2 | Expired Card | 50,000 | 50,000/2 = 25,000 | 4 |
| R3 | Invalid Pin | 70,000 | 70,000/2 = 35,000 | 5 |
| R4 | Do not Honor | 30,000 | 30,000/2 = 15,000 | 3 |

The service platform 114 then takes the highest normalized volume and divides by five (i.e., creating five groups). In the example, above, the highest volume is $35k, whereby the five groups are defined as GRP1=0-7000, GRP2=7001-14000, GRP3=14001-21000, GRP4=21001-28000, and GRP5=28001-35000. The groups are assigned to the recommendation R1-R4 as indicated in the last column of Table 2, for each of the normalized volumes. The group number, in turn, is the business potential for the recommendation, where the higher the number of higher the business potential.

It should be appreciated that for fraud rates, the service platform 114 is configured to consider the maximum gross fraud amount across all the fraud recommendations triggered for the issuer 108, to divide the amount by five groups (as above), and to assign the business potential for the fraud recommendation based on what group their gross fraud values is included in.

The recommendation interface may further include key actions to be taken to implement the recommendations and the technical resources required to take said actions.

The recommendation interface may further include a status bar for the recommendations, which indicates that each recommendation is under review, being implemented, or has been implemented, for example.

In addition to the recommendation interface, the service platform 114 is also configured, in this exemplary embodiment, to display a tracking interface, which includes performance statistics and comparisons against one or more benchmarks (in the industry, the class, etc.), as it relates to the recommendations. The tracking interface includes various filters whereby the user 112 may select based on product, channel, decline reason (for approval recommendations), where the target rates and performance statistics are adjusted consistent with the filter selected. The tracking interface may further include information related to the status of recommendations, whether under implementation, implemented, etc., whereby the contributing impacts of the recommendations may also be indicated.

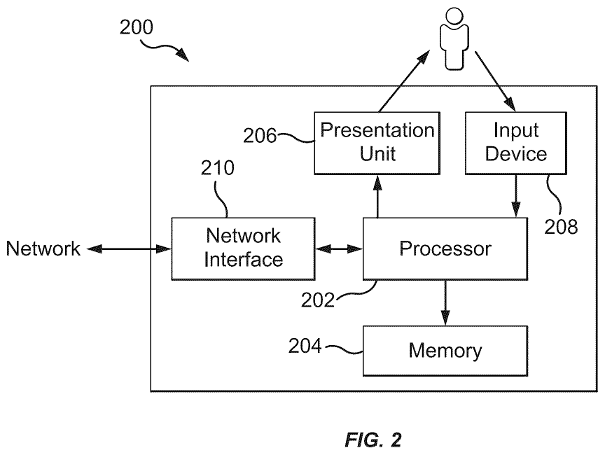

FIG. 2 illustrates an example computing device 200 that can be used in the system 100. The computing device 200 may include, for example, one or more servers, workstations, personal computers, laptops, tablets, smartphones, PDAs, POS devices, etc. In addition, the computing device 200 may include a single computing device, or it may include multiple computing devices located in close proximity or distributed over a geographic region, so long as the computing devices are specifically configured to function as described herein. In particular, in the example system 100 of FIG. 1, each of the first party 102, the acquirer 104, the processing network 106, the issuer 108, the service platform 114, and the data structure 116 may be included, or may be implemented in, at least one computing device consistent with computing device 200. That said, however, the system 100 should not be considered to be limited to the computing device 200, as described below, as different computing devices and/or arrangements of computing devices may be used. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (A SIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROM s, thumb drives, floppy disks, tapes, hard disks, and/or any other type of volatile or nonvolatile physical or tangible computer-readable media. The memory 204 may be configured to store, without limitation, transaction data, recommendations, rates, actions, and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein (e.g., one or more operations of method 300, etc.), such that the memory 204 is a physical, tangible, and non-transitory computer readable storage media. Such instructions often improve the efficiencies and/or performance of the processor 202 that is performing one or more of the various operations herein whereby, in connection with such performance, the computing device 200 may be transformed into a special-purpose computing device. It should be appreciated that the memory 204 may include a variety of different memories, each implemented in one or more of the functions or processes described herein.

In addition, in the example embodiment, the computing device 200 includes a presentation unit 206 that is coupled to (and is in communication with) the processor 202 (however, it should be appreciated that the computing device 200 could include output devices other than the presentation unit 206, etc.). The presentation unit 206 outputs information (e.g., recommendation interfaces including recommendations, actions, business potentials, key actions, etc.), either visually or audibly, to a user of the computing device 200, for example, the user 110, users associated with other parts of the system 100, etc. Various interfaces (e.g., as defined by network-based applications, webpages, short message service (SMS) messages, emails, etc.) may also be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

The computing device 200 also includes an input device 208 that receives inputs from the user of the computing device 200 (i.e., user inputs) such as, for example, selection of categories, selection of recommendations to implement, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. Further, in various example embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter (e.g., a near field communication (NFC) adapter, a Bluetooth adapter, etc.), a mobile network adapter, or other device capable of communicating to/with one or more different networks herein. Further, in some example embodiments, the computing device 200 may include the processor 202 and one or more network interfaces (including the network interface 210) incorporated into or with the processor 202.

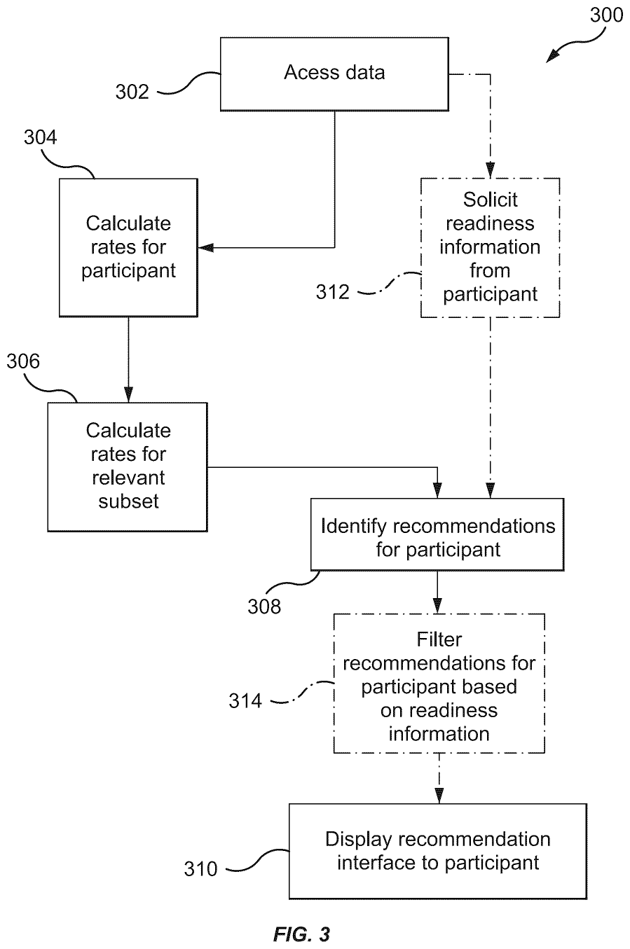

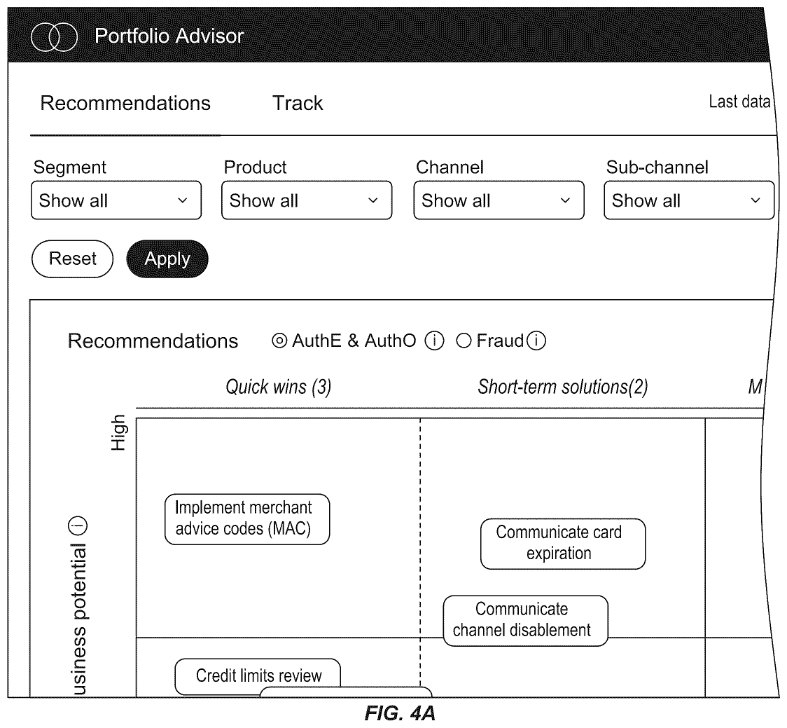

FIG. 3 illustrates an example method 300 for use in identifying recommendations for participants, based on benchmarks. The example method 300 is described as implemented in the system 100 with reference made to the service platform 114 and the data structure 116, and further with reference to computing device 200. However, it should be understood that the method 300 is not limited to this configuration of the system 100, as the method 300 may be implemented, at least in part, in other parts of the system 100, or in multiple other computing devices or systems. As such, the methods herein should not be understood to be limited to the example system 100 or the example computing device 200, and likewise, the systems and the computing devices herein should not be understood to be limited to the example method 300.

At the outset, in method 300, it should be appreciated that the issuer 108 is enrolled with the service platform 114 to receive recommendations related to approval rates and also fraud rates. In connection therewith, the data structure 116 includes transaction data for the issuer 108 representative of transactions spanning a suitable interval (e.g., last year, last two years, or more or less, etc.).

At 302, the service platform 114 access the transaction from the data structure 116. The service platform 114 may initiate method 300, in response to the enrollment of the issuer 108, or a request from the issuer 108 to view recommendations related to the respective rates of the issuer 108, or the issuer 108 accessing an interface associated with the service platform 114.

In any case, in connection with the access, the service platform 114 may access transaction data for the issuer 108 and issuers consistent with one or more criteria (e.g., interval, category, etc.)

At 304, the service platform 114 calculates at least one rate for the issuer 108. The rate, in this exemplary embodiment, may be an approval rate (or decline rate) or a fraud rate. As explained above, the rate is calculated as the total dollars (or number) of approved (or declined) transactions divided by the total dollars (or number) of transactions involving the issuer 108. At 306, the service platform 114 calculates the rate for the transactions included in the transaction data, which involve other issuers. The rate is calculated in the same manner. The rates may include, for example, percentiles of rates for issuers, as benchmarks for use in identifying recommendations. Benchmarks may include one or more percentile of approval rates of the issuer 108 (e.g., 15 percentile, 50 percentile, 85 percentile, etc.), etc. Additionally, or alternatively, the benchmarks may include a prior rate of the issuer 108 for a defined interval. The prior rate for the defined interval may include an approval rate (or fraud rate) for a prior quarter for the issuer 108, or other number of months or years, etc. In one or more examples, the benchmark may include a predefined percentage (e.g., 98%, etc.), upon which the rate of the issuer 108 may be assessed.

It should be appreciated that various benchmarks may be employed, which are based on the transaction data representative of transactions involving the issuer 108 or other participants (or other issuers), etc.

Next, at 308, the service platform 114 identifies recommendations for the issuer 108 based on the calculated rates.

In particular, in this embodiment, the service platform 114 identifies one or more recommendations based on trigger rules associated with the one or more recommendations. Each trigger rule, in this example, defines a relationship between at least one benchmark and the first metric. In various example, the relationship includes a difference, which is then compared to a threshold to identify, or not identify, the recommendation for the issuer 108. For example, related to approval rate recommendations, the relationship may include the 50th percentile approval rate of other issuers minus the approval rate of the issuer 108, which may then be compared to a defined threshold. When the threshold is satisfied, the service platform 114 identifies the associated recommendation for the issuer 108.

It should be appreciated that the service platform 114 may identify numerous recommendations for the issuer 108, based on the associated trigger rules, as they relate to approval rates or fraud rates.

Optionally, the service platform 114 determines a business potential for each of the identified recommendations, based on the description above, and further data from the data structure 116 indicative of the volume of declined transactions and/or the volume of fraud transactions.

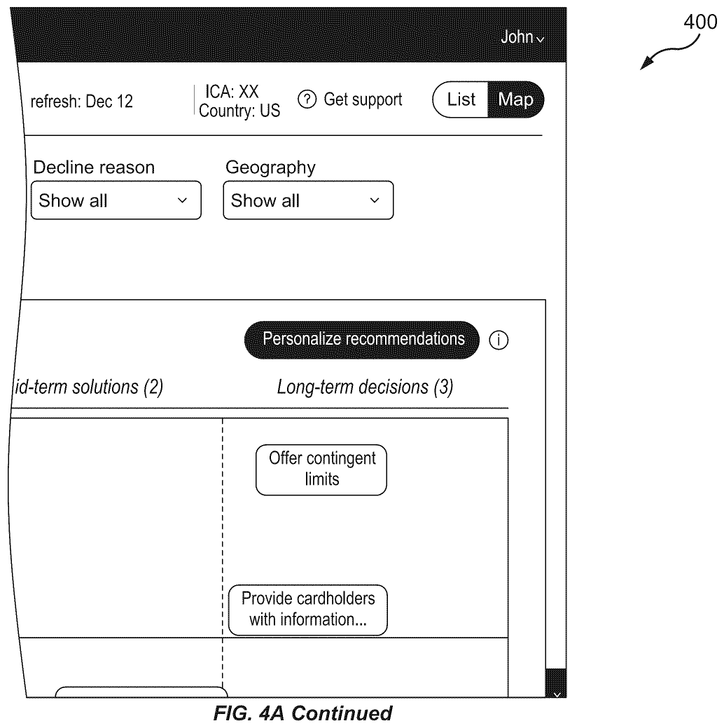

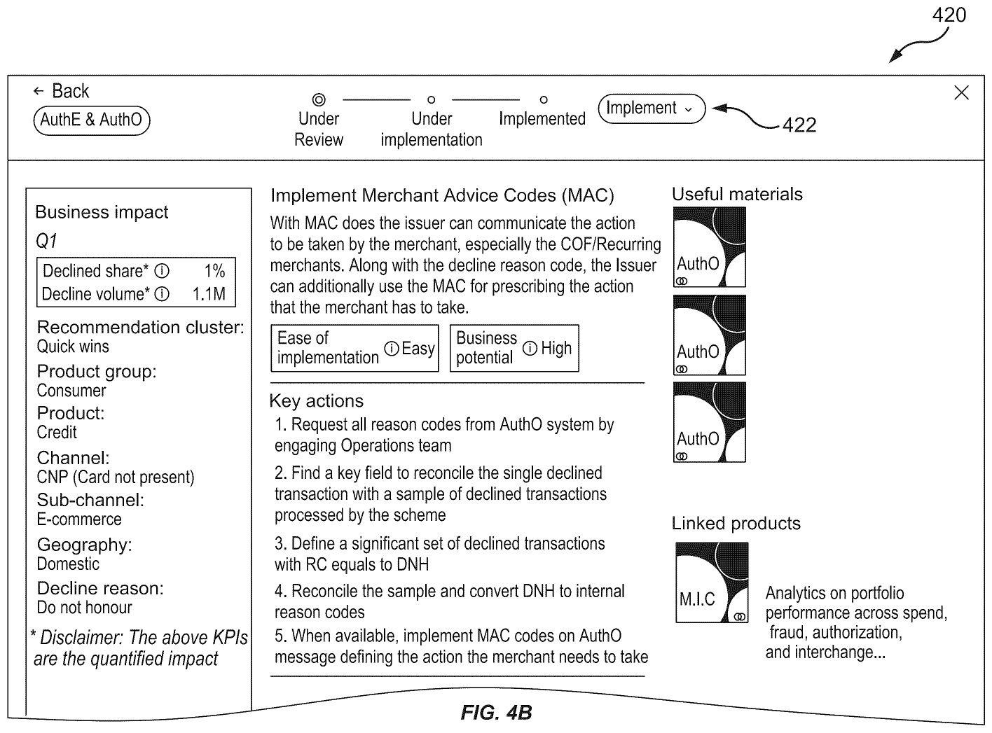

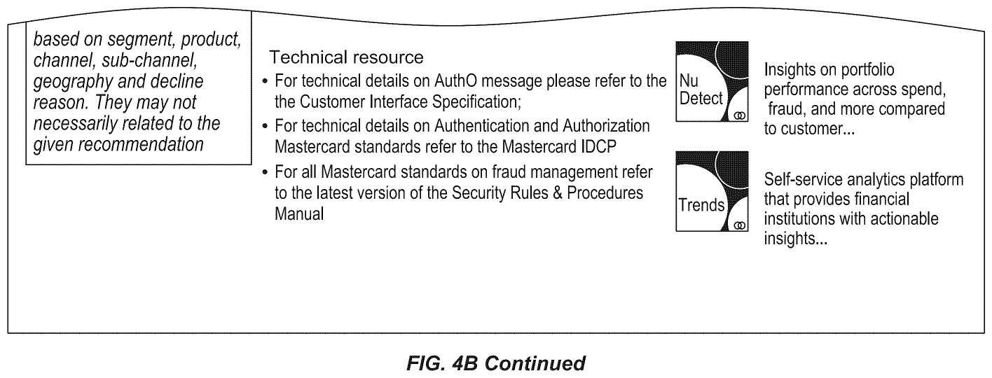

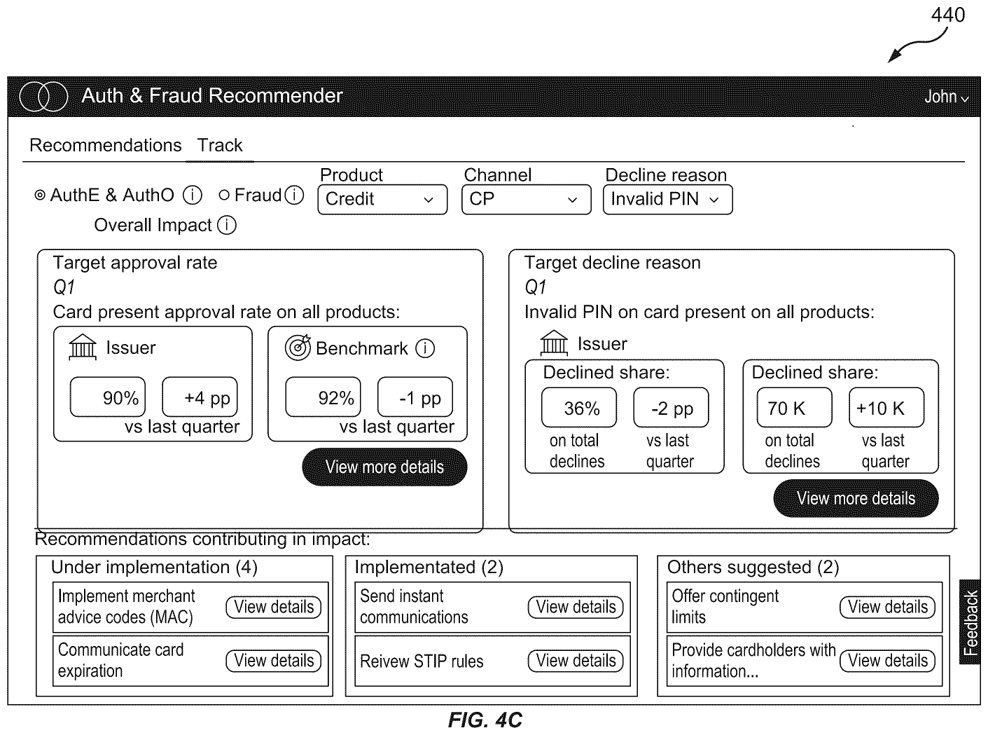

When the recommendations are identified, the service provider 114 displays (e.g., causes to be displayed at a computing device of the user 112, etc.), at 310, the identified recommendations to the user 112, at a computing device associated therewith. In this example embodiment, the recommendations are included as part of a recommendation interface 400, such as, shown, for example, in FIG. 4A. As shown, the recommendations are organized by business potential on one axis and implementation terms on the other axis. It should be understood that the user 112 may select ones of the recommendation for implementation.

What's more, as shown in FIG. 4A, the recommendation interface 400 includes category designations for segment, product, channel, sub-channel, decline reason (for approval rate), and geography. The user 112 is permitted to select a specific category through use of the pulldowns associated with the different categories. In the example shown, the segment is selected as consumer, the product is selected as credit, the channel is selected as CNP (card-not-present), and the sub-channel is selected as e-commerce, while the decline reason and geography are selected as ALL. It should be appreciated, of course, that other selections may be imposed in other examples, or more or less detail may be selected, etc.

By selecting the category, the user 112 limits the recommendation to the specific category. In response, the service platform 114 may return to step 302 and access data in a manner which is limited to the category and then proceed to step 304 and 306 based on the limited data, before displaying only the recommendations suited to the category in the recommendation interface 400, as shown in FIG. 4A. Alternatively, the service platform 114 may limit the recommendations, already identified, to the category selected by the user 112, whereby the selection of the category filters the recommendations already identified by the service platform 114, as explained above.

It should be appreciated that the business potential may be determined again, based on the selection of a new or different category of transaction as well.

Optionally, as indicated by the dotted lines, as shown in FIG. 3, the service platform 114 solicits, at 312, readiness information from the user 112 of the issuer 108. The readiness information is related, in general, to the readiness of the issuer 108 in implementing specific changes to the issuer's processing, rules, procedures, etc., related, in this example, to the authorization, authentication, or fraud operations. In particular, as shown in FIG. 4A, the recommendation interface 400 includes a “Personalize recommendations” button. The user 112 may select the button, whereby the service platform 114 display additional interfaces, which include queries related to the technology readiness, risk and fraud readiness, and marketing readiness. The user 112 responds to the queries, and the service platform 114 receives the readiness information from the user 112 of the issuer 108 and stores the readiness information based on the responses in the data structure 116.

Then, at 314, in FIG. 3, the service platform 114 filters the recommendations further, based on the readiness information from the user 112.

In connection with displaying the recommendations, the user 112 may select a recommendation from the recommendation interface 400, whereby the service platform 114 displays a detailed recommendation interface 420, such as, for example, shown in FIG. 4B. The detailed recommendation interface 420 includes the recommendation, a description of the recommendation, the ease of implementation, the business potential, and a list of actions necessary to be performed by the issuer 108 to implement the recommendation (i.e., Key actions, etc.). In addition, the detailed recommendation interface 420 includes a recommendation tracker status bar 422, which indicates the recommendation is under review. The status bar 422 also includes the potential for under implementation and implemented. As further shown, the detailed recommendation interface 420 includes the category along the left column, from which the recommendation is made, and also a quantification of the business potential/impact from implementation, as explained above, and provides further access to resources related to implementation of the recommendation.

As shown, the interfaces described above, in combination with the service platform 114, provides a user-based interaction solution to identifying, assessing, and implementing one or more recommendations related to decline rates and fraud rates, and other rates, being experienced by the issuer 108.

The service platform 114 further permits the user 112 to track the recommendations and implementation of the same, when selected, through the tracking interface 440, shown in FIG. 4C. As shown, the tracking interface 440 includes issuer information including rates, changes, etc., alone or relative to benchmark information for the region, country, category, etc. It should be appreciated that any suitable information may be included in the tracking interface 440. Further, as shown, the user 112 is permitted, again, to select a category of the recommendations (e.g., by selecting product, channel, and decline reason (if applicable), etc.), and also toggle between approval recommendations and fraud recommendations. What's more, the user 112 is permitted to view the recommendations overall, or select a recommendation to display a detail recommendation tracking interface, which includes similar information specific to that one recommendation (or group of recommendations).

In view of the above, the systems and methods herein enable identification of timely and actionable recommendations to enhance performance, by participants, in permitting proper transactions, while inhibiting improper transactions. By measuring metrics of the participants and utilizing trigger rules (as compared to large scale data assessment, etc.), a service platform identifies recommendations, which are timely and suited to address issues related to improper transactions of the participants. This provides avoidance of comprehensive assessment of the specific participants, in favor of leveraging subject matter expertise (SME) to rapidly identify actionable recommendations suited to the particular metrics of the participants. Recommendations are consequently identified in seconds, as compared to the days, weeks, etc., as with comprehensive assessments of the specific participants' policies, rules, etc., and voluminous data representative of transactions, leading to the specific missed transactions.

In connection with the above, the service platform provides tailored expert advice, which permits prioritizing specific recommendations to solve potential authentication, authorization, and fraud issues, while integrating expert judgement on impact and timeline. The service platform also may integrate user information to more fully understand client strategies, processes and capabilities, etc. The service platform, then, based on the above, is enabled to provide an always-on alert system enabling action, with alerting when actions are needed for participants, providing extensive and tailored guidance/useful materials, and enabling users to track the impact of initiatives.

A gain, and as previously described, it should be appreciated that the functions described herein, in some embodiments, may be described in computer executable instructions stored on a computer readable media, and executable by one or more processors. The computer readable media is a non-transitory computer readable storage medium. By way of example, and without limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations recited herein, including: (a) accessing data specific to a participant, the data representative of multiple transactions; (b) calculating a first metric based on the accessed data, the first metric indicative of a rate of the transaction represented by the accessed data; (c) identifying a recommendation based on a trigger rule, which defines a relationship between at least one benchmark and the first metric; and/or (d) displaying the recommendation to a user associated with the participant.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in identifying recommendations, based on network benchmarks, the method comprising:
accessing, by a service platform computing device, data specific to a participant, the data representative of multiple transactions;
calculating, by the service platform computing device, a first metric based on the accessed data, the first metric indicative of a rate of the transaction represented by the accessed data;
identifying, by the service platform computing device, a recommendation based on a trigger rule, which defines a relationship between at least one benchmark and the first metric; and
displaying, by the service platform computing device, the recommendation to a user associated with the participant.

2. The computer-implemented method of claim 1, wherein the first metric includes one of an approval rate and a fraud rate for transactions represented by the data.

3. The computer-implemented method of claim 1, wherein the at least one benchmark includes a percentile of rates for issuers.

4. The computer-implemented method of claim 3, wherein the first metric is limited to a category of transactions; and
wherein the percentile of rates is limited to transactions of the issuers in the category.

5. The computer-implemented method of claim 4, wherein the category is defined by a product, channel, geography, amount, merchant category code (MCC), and/or product group; and/or
wherein the percentile is either a 50^{th} percentile of rates or an 85^{th} percentile of the rates.

6. The computer-implemented method of claim 1, wherein the at least one benchmark includes a prior rate of the participant for a defined interval.

7. The computer-implemented method of claim 1, further comprising:
soliciting readiness information from the user of the participant;
receiving the readiness information from the user of the participant; and
filtering, by the service platform computing device, the recommendation based on the readiness information.

8. The computer-implemented method of claim 1, wherein the relationship between the at least one benchmark and the first metric includes a difference relative to a defined threshold; and
wherein identifying the recommendation includes identifying the recommendation when the difference satisfies the defined threshold.

9. The computer-implemented method of claim 1, wherein displaying the recommendation includes displaying a recommendation interface, which includes a list of actions to implement the recommendation and a business potential of the recommendation.

10. The computer-implemented method of claim 9, wherein the recommendation interface includes a status of the recommendation.

11. A system for use in identifying recommendations, based on network benchmarks, the system comprising a service platform computing device configured to:
access data specific to a participant, the data representative of multiple transactions;
calculate a first metric based on the accessed data, the first metric indicative of a rate of the transaction represented by the accessed data;
identify a recommendation based on a trigger rule, which defines a relationship between at least one benchmark and the first metric; and
display the recommendation to a user associated with the participant.

12. The system of claim 11, wherein the first metric includes one of an approval rate and a fraud rate for transactions represented by the data; and
wherein the at least one benchmark includes a percentile of rates for issuers.

13. The system of claim 12, wherein the first metric is limited to a category of transactions; and
wherein the percentile of rates is limited to transactions of the issuers in the category.

14. The system of claim 11, wherein the at least one benchmark includes a prior rate of the participant for a defined interval.

15. The system of claim 11, wherein the service platform computing device is further configured to:
solicit readiness information from the user of the participant;
receive the readiness information from the user of the participant; and
filter the recommendation based on the readiness information.

16. The system of claim 11, wherein the relationship between the at least one benchmark and the first metric includes a difference relative to a defined threshold; and
wherein the service platform computing device is configured, in order to identify the recommendation, to identify the recommendation when the difference satisfies the defined threshold.

17. The system of claim 11, wherein the service platform computing device is configured, in order to display the recommendation, to display a recommendation interface, which includes a list of actions to implement the recommendation and a business potential of the recommendation.

18. The system of claim 17, wherein the recommendation interface includes a status of the recommendation.

19. A non-transitory computer-readable storage medium comprising executable instructions, which when executed by at least one processor, cause the at least one processor to:
access data specific to a participant, the data representative of multiple transactions;
calculate a first metric based on the accessed data, the first metric indicative of a rate of the transaction represented by the accessed data;
identify a recommendation based on a trigger rule, which defines a relationship between at least one benchmark and the first metric; and
display the recommendation to a user associated with the participant.

20. The non-transitory computer-readable storage medium of claim 19, wherein the executable instructions, when executed by the at least one processor, further cause the at least one processor to:
solicit readiness information from the user of the participant;
receive the readiness information from the user of the participant; and
filter the recommendation based on the readiness information.
